(19) United States
(12) Patent Application Publication
(10) Pub. No.: US 2006/0053212 A1
(43) Pub. Date: Mar. 9, 2006

(54) Computer network architecture for providing display data at remote monitor

(75) Inventors: Hung-Ming Lin, Hsinchu City (TW); Hung-Ju Huang, Hsinchu City (TW); Fu-Chou Hsu, Hsinchu City (TW)

Correspondence Address: CHARLES E. BAXLEY, ESQ., 90 JOHN STREET, THIRD FLOOR, NEW YORK, NY, 10038, US

(73) Assignee: ASPEED Technology Inc.

(21) Appl. No.: 11/262,183

(22) Filed: Oct. 28, 2005

(51) Int. Cl. G06F 15/16; G09G 5/00; G06F 15/167; G06T 1/00

(52) U.S. Cl. 709/217; 709/216; 709/203; 345/156; 345/204; 345/501

(57) ABSTRACT

A computer network architecture for providing display data at a remote monitor is disclosed. The computer network architecture comprises a local computer, a local user interface controller, a remote user interface controller, and a remote monitor. The local user interface controller electrically connected to the local computer comprises a video compressor, a display timing capture controller, a DDC interface, and a network controller. The remote user interface controller be capable of communicating with the local user interface controller through a network comprises a network controller, a video decompressor, a display timing generator, and a DDC interface. The monitor electrically to the remote user interface controller is used for receiving the decompressed video signals, output signals generated by the display timing generator, and the data structure and displaying the decompressed video signals on the monitor. The present invention utilizes a remote user interface controller (RUIC) and a local user interface controller (LUIC) capable of implementing multi-users to operate local computers via communication lines such as telephone cables or fiber optic networks, among other types of transmission systems without the compatibility issue with the existing hardware and software. In addition, the present invention utilizes a remote user interface controller (RUIC) and a local user interface controller (LUIC) to let users use different KVMs to work on a local computer over a wire or wireless medium without performance impact.

### BACKGROUND OF THE PRESENT INVENTION

1. Field of Invention

This invention relates to a computer network architecture for providing display data at a remote monitor, and more particularly to a computer network architecture utilizing a local user interface controller and a remote user interface controller for implementing multi-users to operate local computers via communication lines.

2. Description of Related Arts

Conventional technologies such as “thin-client networks” and “KVM extender” have been developed in order to increase the distance by which an operator control center can be separated from a computer. Many industries rely on thin-client networks to conduct business and manage their information. In client/server applications, a client computer is typically designed to be small (i.e., with limited processing resources) so that the bulk of the data processing occurs on the application server. A thin client is typically thought of as a computer without local storage and with a lower speed CPU (central processing unit), whereas a fat client includes local storage. A thin client typically includes a hardware platform (e.g., local memory, local processor, keyboard, pointing device, and a display device), a local small operating system (e.g., Windows CE.™. from Microsoft Corporation), and one or more client programs that when executed allow the thin client to connect to an application server configured to execute programs on behalf of the thin client. In contrast, a fat client is a computer with a full-featured hardware platform (e.g., including peripherals such as CD-ROM), a large, full-featured operating system, and local applications which are executed on the fat client as opposed to an application server. Some thin clients may be designed to only connect to application servers, whereas other thin clients may be designed to also connect to the Internet.

In a computer system, electronic signals must be transmitted from the computer to a keyboard, a video monitor, a mouse, and any other peripheral devices coupled to the computer. The acronym KVM will be used herein to mean “keyboard, video monitor, and mouse,” following a practice that is standard in the art. Additionally, the phrase “peripheral device” will be used herein to mean any electronic device coupled to a computer or forming a part of any electronic system, including a keyboard, a video monitor, and a mouse. One example of such a circumstance is where a single keyboard, video monitor, and mouse, referred to collectively herein as an “operator control center” or an “OCC,” are adapted to control several computers, where the several computers may be located at a distance from the operator control center. Existing KVM extenders include a local subsystem, a remote subsystem, and a cable coupled between the local and remote subsystems. The local subsystem is coupled to a computer and/or, if applicable, to a KVM Switch that switches control from one to another of several computers being controlled by an operator control center. The remote subsystem is coupled to the OCC. Electronic signals may be transmitted between the computer and the OCC across the cable via the local and remote subsystems.

Pursuant to the above conventional technology, “thin-client networks”, two exemplary thin client protocols are ICA, Independent Computing Architecture from Citrix Systems, Inc., Ft. Lauderdale, Fla. and RDP, Remote Desktop Protocol from Microsoft, Inc., Redmond, Wash. The main shortcoming of the conventional technology “thin-client networks” is that the compatibility issue particularly when the network includes different computers with different hardware and software configurations. With regard to the above conventional technology, “KVM extender”, the KVM systems require a point-to-point connection between each remote computers and the “operator control center”. In many applications this is not a problem as long as the point-to-point cable assembly is easy to install and not expensive. However, in some applications the star wiring from the “operator control center” to the remote computers is not practical. For example, applications that cannot support large groupings of cable assemblies that generally occur near the “operator control center” and along common cabling paths, as well as applications in which the cable assemblies implementing the point-to-point connections cannot be implemented as one monolithic cable but are formed by connecting multiple cable segments. In order to overcome these shortcoming, thus a simple and easy set-up user interface controller is desired to transfer multiple data streams over a wire or wireless medium and prevent the performance impact and compatibility issue with the existing hardware and software.

### SUMMARY OF THE PRESENT INVENTION

A main object of the present invention is to provide a computer network utilizing a remote user interface controller (RUIC) and a local user interface controller (LUIC) capable of implementing multi-users to operate local computers via communication lines such as telephone cables or fiber optic networks, among other types of transmission systems.

Another object of the present invention is to provide a computer network utilizing a remote user interface controller (RUIC) and a local user interface controller (LUIC), in which multi-users use different KVMs to operate the local computer through the network, where the local computer may be located at a distance from multi-users.

Another object of the present invention is to provide a computer network utilizing a remote user interface controller (RUIC) and a local user interface controller (LUIC), in which the local computer serves as a work station to let different users to work on it via Internet, where multi-users may be located at a distance far away from the local computer.

Another object of the present invention is to provide a computer network utilizing simple and easy set-up remote user interface controllers, user interface controller (RUIC) and a local user interface controller (LUIC), to let users use different KVMs to work on a local computer over a wire or wireless medium without the compatibility issue with the existing hardware and software.

Another object of the present invention is to provide a computer network utilizing a remote user interface controller (RUIC) and a local user interface controller (LUIC) to let users use different KVMs to work on a local computer over a wire or wireless medium without performance impact.

Another object of the present invention is to provide a computer network utilizing a remote user interface controller (RUIC) and a local user interface controller (LUIC) to let users use different KVMs to work on a local computer via Internet, in which the system could accomplish a high-quality real-time image transmission through network even though multi-users share the same bandwidth of Internet.

Accordingly, in order to accomplish the one or some or all above objects, the present invention provides a display system comprising:
a local computer be capable of providing video signals, display timing signals, and data structure specifying a plurality of timing parameters associated with a supported video format;
a local user interface controller electrically connected to the local computer, comprising:
   a video compressor be capable of receiving the video signals and generating compressed video signals;
   a display timing capture controller electrically connected to the local computer for receiving the display timing signals;
   an interface electrically connected to the local computer be capable of receiving the data structure; and
   a network controller electrically connected to the video compressor, the display timing capture controller, and the interface for receiving the compressed video signals, the data structure, and the output signals generated by the display timing capture controller;
a remote user interface controller be capable of communicating with the local user interface controller through a network, comprising:
   a network controller electrically connected to the network for communicating with the network controller of the local user interface controller through the network;
   a video decompressor electrically connected to the network controller for receiving the compressed video signals and generating decompressed video signals;
   a display timing generator electrically connected to the network controller of the remote user interface controller for receiving the display timing signals;
   an interface electrically connected to the network controller of the remote user interface controller for receiving the data structure; and
a monitor electrically to the remote user interface controller for receiving the decompressed video signals, output signals generated by the display timing generator, and the data structure and displaying the decompressed video signals on the monitor.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a diagrammatic representation of a computer network illustrating the interconnection of a local computer and remote peripheral devices according to a preferred embodiment of the present invention.

FIG. 2A illustrates a diagrammatic representation of a computer network illustrating the interconnection of a local computer and a local user interface controller (LUIC) according to the above preferred embodiment of the present invention.

FIG. 2B is a diagrammatic representation of a computer network illustrating the interconnection of peripheral devices and a remote user interface controller (RUIC) according to the above preferred embodiment of the present invention.

### DETAILED DESCRIPTION OF THE PREFERRED EMBODIMENT

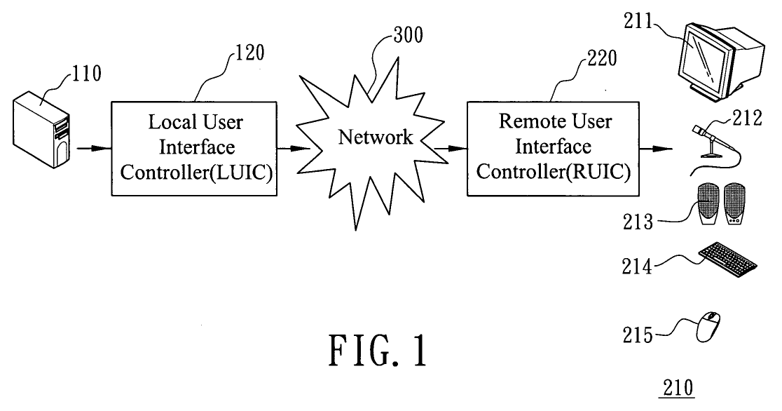

Referring to FIG. 1, a diagrammatic representation of a computer network illustrating the interconnection of a local computer and remote peripheral devices according to a preferred embodiment of the present invention is illustrated. As shown in FIG. 1, the computer network comprises a local computer 110, a local user interface controller (LUIC) 120, peripheral devices 210, and a remote user interface controller (RUIC) 220. The local user interface controller 120 is electrically connected between the local computer 110 and the network 300. In other words, the local computer 110 is connected to the network 300 via the local user interface controller 120. Electronic signals such as video signals, horizontal synchronization (Hsync) and vertical synchronization (Vsync) signals, and audio signals are transmitted between the local user interface controller 120 and the local computer 110. The local computer 110 can transmit electronic signals to the network 300 through the local user interface controller 120. In the video signals, the color “component” signals (e.g., red, green and blue) are carried on separate wires. Video synchronization can be signaled by either dedicated horizontal synchronization (Hsync) and vertical synchronization (Vsync) signals, as is normally the case for PC graphics, or both types of synchronization signals can be combined into a single “composite synchronization” signal. Additionally, the local computer 110 may use a DDC (display data channel) to carry Extended Display Identification Data (EDID) information as a communication protocol for a communication with the local user interface controller 120 (EDID is a VESA standard data format that contains basic information about a monitor and its capabilities, including vendor information, maximum image size, color characteristics, factory pre-set timings, frequency range limits, and character strings for the monitor name and serial number. The information is stored in the display and is used to communicate with the system through the DDC which sites between the monitor and the PC graphics adapter. The system uses this information for configuration purposes, so the monitor and system can work together). In addition, a universal serial bus (USB) transport for peripheral attachment can be utilized to support additional data types such as keyboard, mouse and microphone.

Similarly, the remote user interface controller (RUIC) 220 is electrically connected between peripheral devices 210 and the network 300. In other words, peripheral devices 210 are connected to the network 300 via the remote user interface controller 220. Electronic signals such as video signals, horizontal synchronization (Hsync) and vertical synchronization (Vsync) signals, and audio signals are transmitted between the remote user interface controller 220 and the peripheral devices 210 such as a monitor 211, a microphone 212, a speaker 213, a keyboard 214, and a mouse 215. The remote user interface controller 220 can communicate with the local user interface controller 120 through the network 300. In other words, the peripheral devices 210 communicate with the local computer 110 through the remote user interface controller 220. Additionally, the peripheral devices 210 also may use DDC (display data channel) to carry Extended Display Identification Data (EDID) information as a communication protocol for a communication with the local computer 110 through the local user interface controller 120, the remote user interface controller 220, and the network 300. In addition, a universal serial bus (USB) transport for peripheral attachment can be utilized to support additional data types such as keyboard, mouse and microphone.

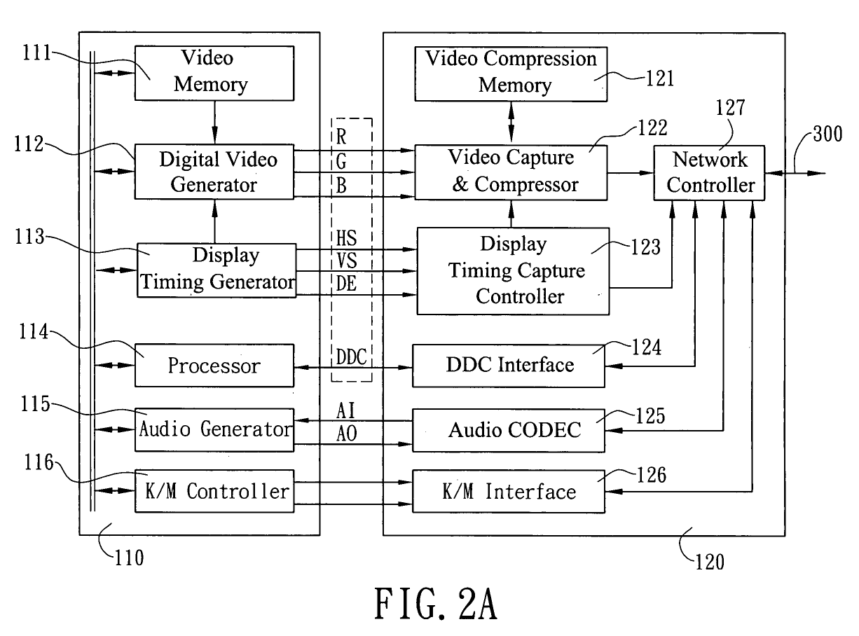

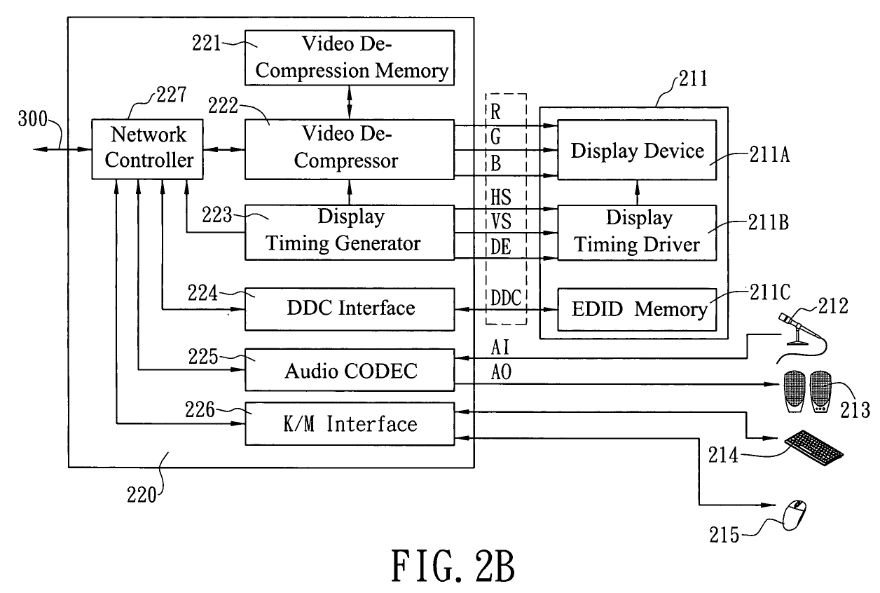

Referring to FIG. 2A, a diagrammatic representation of a computer network illustrating the interconnection of a local computer and a local user interface controller (LUIC) according to the above preferred embodiment of the present invention is illustrated. As shown in FIG. 2A, the local computer 110 comprises a video memory 111, a digital video generator 112, a display timing generator 113, a processor 114, an audio generator 115, and a keyboard mouse (K/M) controller 116. The local user interface controller (LUIC) 120 comprises a video compression memory 121, a video compressor 122, a display timing capture controller 123, a DDC (display data channel) interface 124, an Audio codec 125, a keyboard mouse interface 126, and a network controller 127. The video compressor 122 receives video signals generated by the digital video generator 112 and generates compressed video signals. Most modern image compression techniques such as the Joint Photographic Experts Group (JPEG) standard, the motion-picture-experts group MPEG standard, could be applied to the video compressor but not limited to the above conventional image compression techniques. In the video signals, the color “component” signals (e.g., red, green and blue) are carried on separate wires. The display timing generator 113 provides display timing signals such as horizontal synchronization (HS) and vertical synchronization (VS) signals to the display timing capture controller 123. The processor 114 utilizes a DDC (display data channel) to carry Extended Display Identification Data (EDID) information as a communication protocol for a communication with a DDC interface 124 of the local user interface controller 120. The audio generator 114 communicates with the audio codec 125. The keyboard mouse (K/M) controller 116 communicates with the keyboard mouse interface 126. The network controller 127 receives output signals generated by the video and compressor 122 and output signals generated the display timing capture controller 123 and then utilizes Extended Display Identification Data (EDID) information to transmit electronic signals to the remote user interface controller (RUIC) 220. In addition, the network controller 127 also communicates with the audio codec 125 and the keyboard and mouse interface to transmit the related data signals. Also, the network controller 127 is able to transmit and receive such data signals having different transmission rates and different network protocols. Accordingly, the network controller 127 could receive or transmit a packet through the network 300, determine a priority assigned to the packet, output the packet when the packet is determined to be a transit packet having a relatively higher priority, transmit the packets for at least some packets determined to have a relatively lower priority, . . . , etc.

Referring to FIG. 2B, a diagrammatic representation of a computer network illustrating the interconnection of peripheral devices and a remote user interface controller (LUIC) according to the above preferred embodiment of the present invention is illustrated. As shown in FIG. 2B, the remote user interface controller 220 comprises a video decompression memory 221, a video decompressor 222, a display timing generator 223, a DDC interface 224, an Audio codec 225, a keyboard and mouse interface 226, and a network controller 227. The network controller 227 of the remote user interface controller 220 communicates with the network controller 127 of local user interface controller 120. In other words, the network controller 227 receives output signals generated by the video and compressor 122 and output signals generated the display timing capture controller 123 through the network 300 and the network controller 127. Additionally, the Extended Display Identification Data (EDID) information is transmitted through the DDC interface 124, the network controller 127, and the network 300 to the network controller 227. The network controller 227 communicates with the video compressor 222 such that the video decompressor 222 receives compressed video signals and generates decompressed video signals which are transmitted to a display device 211A of the monitor 211. Most modern image decompression techniques such as the Joint Photographic Experts Group (JPEG) standard, the motion-picture-experts group MPEG standard, could be applied to the video decompressor but not limited to the above conventional image decompression techniques. Furthermore, the network controller 227 communicates with the display timing generator 223 and the DDC interface 224 such that the display timing generator 223 provides display timing signals such as horizontal synchronization (HS) and vertical synchronization (VS) signals to a display timing drive 211B of the monitor 211, and the network controller 227 communicates with the EDID memory 211C of the monitor 211. In addition, the network controller 227 could have the same function. The network controller 227 is able to transmit and receive such data signals having different transmission rates and different network protocols. Accordingly, the network controller 227 could receive or transmit a packet through the network 300, determine a priority assigned to the packet, output the packet when the packet is determined to be a transit packet having a relatively higher priority, transmit the packets for at least some packets determined to have a relatively lower priority, . . . , etc. Therefore, a Video image stored on the local computer could be displayed on the display device 211A of the monitor 211 through the remote user interface controller (RUIC) 220 and the local user interface controller (LUIC) 120. Similarly, the microphone 212, the speaker 213, the keyboard 214, or the mouse 215 could utilize the remote user interface controller (RUIC) 220 and the local user interface controller (LUIC) 120 to communicate the local computer 110 through the network 300.

In conclusion, the present invention provides a remote user interface controller (RUIC) and a local user interface controller (LUIC) capable of implementing multi-users to operate local computers via communication lines such as telephone cables or fiber optic networks, among other types of transmission systems. Hence anyone remote user utilizes a keyboard, a video monitor, a mouse, and any other peripheral devices which are coupled to the local computer through the remote user interface controller (RUIC) and the local user interface controller (LUIC). One example of such a circumstance is where multi-users use different KVMs to operate the local computer through the network, where the local computer may be located at a distance from multi-users. In other words, the local computer serves as a work station to let different users to work on it via Internet, where multi-users may be located at a distance far away from the local computer. Thus, the present invention provides a simple and easy set-up user interface controller to let users use different KVMs to work on a local computer over a wire or wireless medium without the compatibility issue with the existing hardware and software. On the other hand, the present invention utilizes a video compressor to provide compressed video signals which are transmitted to a remote user interface controller (RUIC) via Internet. Hence when some or all of the users use different KVMs to work on a local computer over the network, the system performance may not be limited by the overall bandwidth of Internet because the compressed video signals have greatly reduced the transmission loading of Internet. Thus, the present invention provides a simple and easy set-up user interface controller to let users use different KVMs to work on a local computer over a wire or wireless medium without performance impact.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system comprising:
a local computer be capable of providing video signals, display timing signals, and data structure specifying a plurality of timing parameters associated with a supported video format;
a local user interface controller electrically connected to said local computer, comprising:
a video compressor be capable of receiving said video signals and generating compressed video signals;
a display timing capture controller electrically connected to said local computer for receiving said display timing signals;
an interface electrically connected to said local computer be capable of receiving said data structure; and
a network controller electrically connected to said video compressor, said display timing capture controller, and said interface for receiving said compressed video signals, said data structure, and said output signals generated by said display timing capture controller;
a remote user interface controller be capable of communicating with said local user interface controller through a network, comprising:
a network controller electrically connected to said network for communicating with said network controller of said local user interface controller through said network;
a video decompressor electrically connected to said network controller for receiving said compressed video signals and generating decompressed video signals;
a display timing generator electrically connected to said network controller of said remote user interface controller for receiving said display timing signals;
an interface electrically connected to said network controller of said remote user interface controller for receiving said data structure; and
a monitor electrically to said remote user interface controller for receiving said decompressed video signals, output signals generated by said display timing generator, and said data structure and displaying said decompressed video signals on said monitor.

2. The display system, as recited in claim 1, wherein said data structure comprises Extended Display Identification Data information.

3. The display system, as recited in claim 1, wherein said display timing signals are horizontal synchronization (Hsync) and vertical synchronization (Vsync) signals.

4. The display system, as recited in claim 1, wherein said interface of said local user interface controller is a DDC interface.

5. The display system, as recited in claim 1, wherein said interface of said remote user interface controller is a DDC interface.

6. A local user interface controller applied to a local computer of a display system for providing video signals at a remote monitor, comprising:
a video compressor be capable of receiving said video signals generated by said local computer and generating compressed video signals;
a display timing capture controller electrically connected to said local computer for receiving said display timing signals; and
a network controller electrically connected to said video compressor and said display timing capture controller for receiving said compressed video signals and said output signals generated by said display timing capture controller, wherein said network controller outputs said compressed video signals and said output signals generated by said display timing capture controller to said remote monitor through a network.

7. The local user interface controller, as recited in claim 6, further comprises an interface electrically connected to said local computer be capable of receiving data structure specifying a plurality of timing parameters associated with a supported video format, wherein said network controller electrically connected to said interface for receiving said data structure and outputting said data structure to said remote monitor through said network.

8. The local user interface controller, as recited in claim 7, wherein said data structure comprises Extended Display Identification Data information.

9. The local user interface controller, as recited in claim 7, wherein said interface of said local user interface controller is a DDC interface.

10. The local user interface controller, as recited in claim 8, wherein said interface of said local user interface controller is a DDC interface.

11. The local user interface controller, as recited in claim 6, wherein said display timing signals are horizontal synchronization (Hsync) and vertical synchronization (Vsync) signals.

12. The local user interface controller, as recited in claim 10, wherein said display timing signals are horizontal synchronization (Hsync) and vertical synchronization (Vsync) signals.

13. A remote user interface controller be capable of communicating with a local user interface controller through a network and providing video signals at a remote monitor, comprising:
a network controller electrically connected to said network for communicating with said local user interface controller through said network;
a video decompressor electrically connected to said network controller for receiving said compressed video signals generated by said local user interface controller and generating decompressed video signals; and
a display timing generator electrically connected to said network controller for receiving said display timing signals, wherein said decompressed video signals and said display timing signals are outputted to said remote monitor for displaying said decompressed video signals on said remote monitor.

14. The remote user interface controller, as recited in claim 13, further comprises an interface electrically connected to said network controller be capable of receiving data structure specifying a plurality of timing parameters associated with a supported video format and outputting said data structure to said remote monitor.

15. The remote user interface controller, as recited in claim 14, wherein said data structure comprises Extended Display Identification Data information.

16. The remote user interface controller, as recited in claim 14, wherein said interface of said local user interface controller is a DDC interface.

17. The remote user interface controller, as recited in claim 15, wherein said interface of said local user interface controller is a DDC interface.

18. The remote user interface controller, as recited in claim 13, wherein said display timing signals are horizontal synchronization (Hsync) and vertical synchronization (Vsync) signals.

19. The remote user interface controller, as recited in claim 17, wherein said display timing signals are horizontal synchronization (Hsync) and vertical synchronization (Vsync) signals.
